(19) United States
(12) Patent Application Publication
(10) Pub. No.: US 2008/0301285 A1
(43) Pub. Date: Dec. 4, 2008

(54) Methods, apparatus and systems for analyzing data carried by a plurality of data tributaries, wherein the analysis is based on a mapping of the data tributaries to one or more tributary sets

(76) Inventors: Robert Geoffrey Ward, Colorado Springs, CO (US); Robert Herman Kroboth, Peyton, CO (US); Andrew McArthur, Colorado Springs, CO (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/809,701

(22) Filed: Jun. 1, 2007

(51) Int. Cl. G06F 12/00; G06F 15/173

(52) U.S. Cl. 709/224; 711/1; 711/E12.001

(57) ABSTRACT

In one embodiment, data carried by a plurality of data tributaries is received. As the data is received, a stored mapping of data tributaries to one or more tributary sets is accessed, and common data tags are assigned to the data carried by ones of the data tributaries mapped to common ones of the one or more tributary sets. The data based on the common data tags is filtered; the filtered data is analyzed; and a result of the analysis is output. Other embodiments are also disclosed.

### BACKGROUND

Data is commonly transmitted over telecommunications networks such as 2G and 3G networks (i.e., 2^{nd} and 3^{rd} Generation wireless communication networks). Although various ways of analyzing data transmitted over such networks exist today, new and better ways to analyze data are always being sought.

### BRIEF DESCRIPTION OF THE DRAWINGS

Illustrative embodiments of the invention are illustrated in the drawings, in which:

FIG. 1 illustrates an exemplary computer-implemented method 100 for analyzing data carried by a plurality of data tributaries, wherein the analysis is based on a mapping of the data tributaries to one or more tributary sets;

FIG. 2 illustrates an exemplary system for providing the data and data tributaries on which the method operates;

FIG. 3 illustrates an exemplary embodiment of the network analyzer shown in FIG. 2; and

FIG. 4 illustrates an exemplary embodiment of one of the GUIs shown in FIG. 2.

### DETAILED DESCRIPTION

As a preliminary manner, it is noted that, in the following description, like reference numbers appearing in different drawing figures refer to like elements/features. Often, therefore, like elements/features that appear in different drawing figures will not be described in detail with respect to each of the drawing figures.

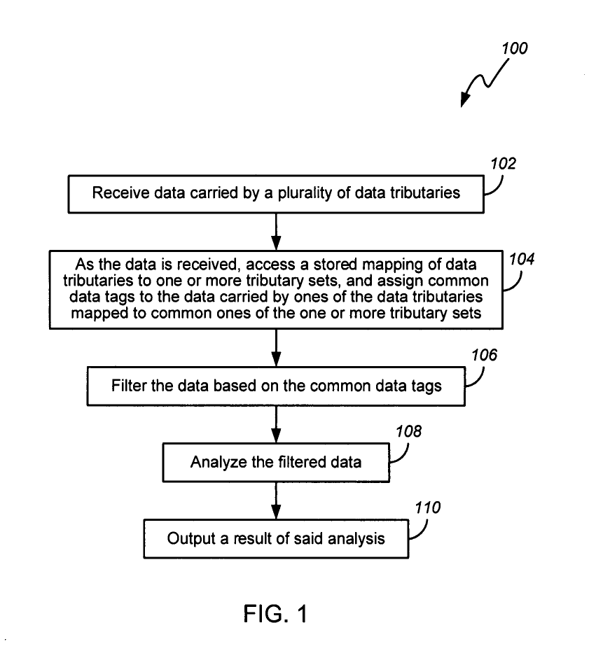

FIG. 1 illustrates an exemplary computer-implemented method 100 for analyzing data carried by a plurality of data tributaries, wherein the analysis is based on a mapping of the data tributaries to one or more tributary sets. By way of example, the data tributaries may be T1 or E1 tributaries carrying Asynchronous Transfer Mode (ATM) data; and the tributary sets may be sets of data tributaries that correspond to different network base stations, such as different mobile phone towers.

The method 100 begins with the receipt of data carried by a plurality of data tributaries (at block 102). As the data is received, a stored mapping of data tributaries to one or more tributary sets is accessed, and common data tags are assigned to the data carried by ones of the data tributaries mapped to common ones of the one or more tributary sets (at block 104). The data is then filtered based on the common data tags (at block 106); the filtered data is analyzed (at block 108); and a result of the analysis is output (at block 110).

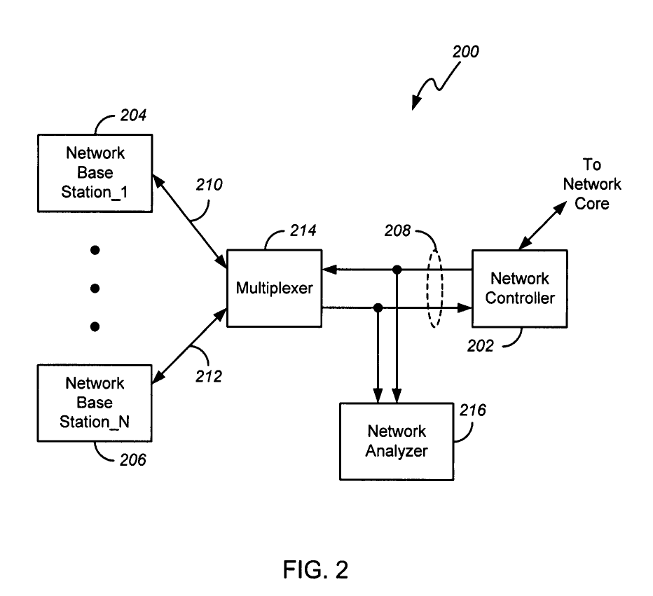

FIG. 2 illustrates an exemplary system 200 for providing the data and data tributaries on which the method 100 operates. As shown, the system 200 comprises a network controller 202, a plurality of network base stations 204, 206, a primary data link 208, a plurality of secondary data links 210, 212 and a data multiplexer 214. The data multiplexer 214 is coupled to each of the network base stations 204, 206 via respective ones of the secondary data links 210, 212, and is coupled to the network controller 202 via the primary data link 208. Each of a plurality of data tributaries carries data over the secondary data links 210, 212, between a particular one of the network base stations (204 or 206) and the data multiplexer 214; and multiplexed ones of the data tributaries carry data over the primary data link 208, between the data multiplexer 214 and the network controller 202.

In one embodiment, the system 200 may be a 3G system, wherein the network controller 202 is a Radio Network Controller (RNC), the network base stations 204, 206 are Node B's (cell phone towers), and the primary data link is an lub link.

One possible physical implementation of the lub link is via a set of four STM-1 or OC-3 optical fibers, each having a data transmission rate of 155.52 Megabits/second (Mbits/sec). Each STM-1 fiber may be internally configured to carry 84 T1 data tributaries or 63 E1 data tributaries, for a total lub capacity of 336 T1's or 252 E1's.

Each of the T1 or E1 data tributaries may carry ATM data, including both signaling information and user data (such as voice, internet or video data).

In another embodiment, the system 200 may be a 2G system, wherein the network controller 202 is a Base Station Controller (BSC), the network base stations 204, 206 are Base Transceiver Stations (BTS's), and the primary data link is an A-bis link.

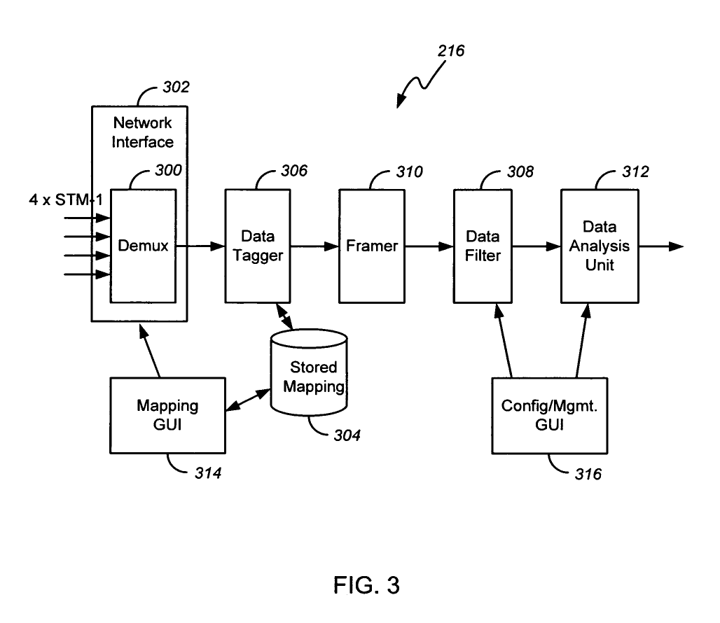

FIG. 2 also illustrates a network analyzer 216. The network analyzer 216 comprises a network interface 300 (FIG. 3) that may, in some cases, be coupled to the primary data link 208 via an optical splitter. The network interface 300 is configured to receive the data that is carried over the primary data link 208 via the plurality of data tributaries. Given that the data tributaries may be carried over the primary data link 208 in multiplexed form, the network interface 300 may comprise a demultiplexer 302 to i) receive the data tributaries in multiplexed form, ii) demultiplex the data tributaries, and iii) provide the demultiplexed data tributaries to a data tagger 306.

The network analyzer 216 also comprises a stored mapping of data tributaries to one or more tributary sets 304. The data tagger 306 is configured to i) access the stored mapping of data tributaries to one or more tributary sets 302, and ii) assign common data tags to the data carried by ones of the data tributaries that are mapped to common ones of the one or more tributary sets. Thus, for example, the data carried by all of the data tributaries mapped to a first tributary set would be assigned a first tag, and the data carried by all of the data tributaries mapped to a second tributary set would be assigned a second tag. In one embodiment, all of the data tributaries provisioned to a particular network base station (204 or 206) are mapped to a common tributary set, and the data tributaries provisioned to different network base stations 204, 206 are mapped to different tributary sets.

A data filter 308 is configured to filter data based on the data tags that are assigned by the data tagger 306. In this manner, data items may be filtered (or grouped) based on the commonality of their data tags.

Optionally, a framer 310 may be configured to i) receive tagged data from the data tagger 306, ii) delineate ATM cells in the tagged data, and iii) provide the tagged data of the delineated ATM cells to the data filter 308.

A data analysis unit 312 is configured to analyze the filtered data and output a result of the analysis (e.g., to a user or network controller). In one embodiment, the data analysis unit 312 may be configured to generate a report that identifies an item of the filtered data as being associated with a particular tributary set (e.g., a report of data items transmitted to or from a particular one of the network base stations 204, 206, such as a call or data trace report). In another embodiment, the data analysis unit 312 may be configured to generate a report that includes statistics by tributary set (e.g., statistics for one or more of the network base stations 204, 206, such as packet count, CRC error count, or utilization).

The network analyzer 216 is useful in that it enables data to be analyzed in useful groupings, such as groupings by network base station 204, 206. In the context of a call or data trace, for example, the network analyzer 216 enables the trace of calls or other data items carried on data tributaries that are assigned the same identifier by different network base stations 204, 206.

In one embodiment, the network analyzer 216 may comprise a graphical user interface (GUI) 314 that is configured to receive user input for mapping the data tributaries to the one or more tributary sets. See, FIGS. 3 & 4. By way of example, the GUI 314 may display i) a mechanism 400 for selecting or providing an identifier of a particular tributary set (e.g., a tributary set name), and ii) a bingo card 402 for selecting ones of the data tributaries to add to the particular tributary set.

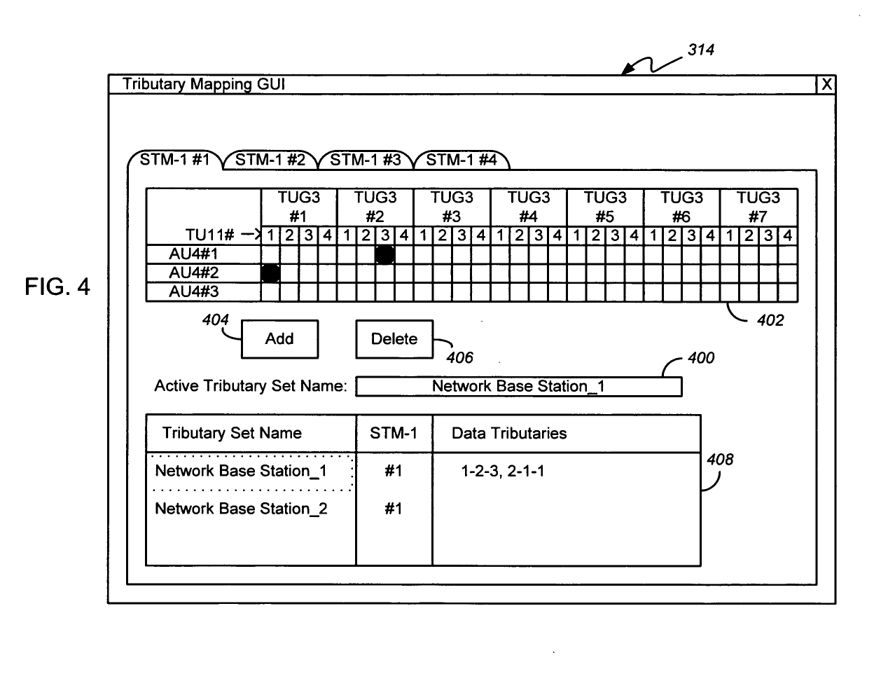

As shown in FIG. 4, the bingo card 402 may provide a means such as a checkbox or pushbutton for selecting data tributaries identified by a tuple of: AU4#/AU3#/TU#, or AU4#/TUG#/TU#, or STS-1 #/VT-Group#/VT#. As shown, for an lub comprised of four STM-1's, the bingo card 402 may also be associated with tabs for identifying data tributaries by STM-1 port, in addition to a tuple.

After selecting a number of data tributaries via the bingo card 402, a user may graphically click an “Add” button 404 or “Delete” button 406, to add or delete the selected data tributaries to a particular tributary set selected in the window 408.

As shown in FIG. 3, the network analyzer 216 may also comprise a GUI 316 that provides a mechanism that enables a user to define a configuration for the data tributaries of a tributary set. The GUI 316 may also provide a mechanism that enables the user to copy a configuration defined for one tributary set to a second tributary set, thereby streamlining the configuration and management of data tributaries by tributary set.

Although the network analyzer 216 is shown in FIGS. 2 & 3 as a discrete unit, the components of the network analyzer 216 may alternately be distributed across a network. For example, the network interface 300 may comprise multiple components coupled to multiple different data links, or the data analysis unit 312 may be partly or wholly implemented on a personal computer that is coupled to the other components of the network analyzer over a Universal Serial Bus (USB), Internet or other data connection.

What is claimed is:

1. A network analyzer, comprising:
a network interface configured to receive data carried by a plurality of data tributaries;
a stored mapping of data tributaries (T1 or E1) to one or more tributary sets;
a data tagger configured to i) access the stored mapping of data tributaries to one or more tributary sets, and ii) assign common data tags to the data carried by ones of the data tributaries mapped to common ones of the one or more tributary sets;
a data filter configured to filter the data based on the common data tags; and
a data analysis unit configured to analyze the filtered data and output a result of said analysis.

2. The network analyzer of claim 1, wherein the tributary sets correspond to different network base stations.

3. The network analyzer of claim 1, wherein the data analysis unit is configured to generate a report that identifies an item of the filtered data as being associated with a particular tributary set.

4. The network analyzer of claim 1, wherein the data analysis unit is configured to generate a report that includes statistics by tributary set.

5. The network analyzer of claim 1, wherein:
the network interface is configured to i) receive the data tributaries in multiplexed form, ii) demultiplex the data tributaries, and iii) provide the demultiplexed data tributaries to the data tagger; and
the network analyzer further comprises a framer configured to i) receive tagged data from the data tagger, ii) delineate Asynchronous Transfer Mode (ATM) cells in the tagged data, and iii) provide the tagged data of the delineated ATM cells to the data filter.

6. The network analyzer of claim 1, further comprising a graphical user interface (GUI), wherein the GUI provides a mechanism for the user to define a configuration for the data tributaries of a tributary set.

7. The network analyzer of claim 6, wherein the GUI further provides a mechanism for the user to copy a configuration defined for one tributary set to a second tributary set.

8. The network analyzer of claim 1, wherein components of the network analyzer are distributed across a network.

9. A network analyzer, comprising:
a network interface configured to receive data carried by a plurality of data tributaries;
a graphical user interface (GUI) configured to receive user input for mapping data tributaries to one or more tributary sets;
a data tagger configured to i) access the mapping of data tributaries to one or more tributary sets, and ii) assign common data tags to the data carried by ones of the data tributaries mapped to common ones of the one or more tributary sets;
a data filter configured to filter the data based on the common data tags; and
a data analysis unit configured to analyze the filtered data and report a result of said analysis.

10. The network analyzer of claim 9, wherein the GUI displays i) a mechanism for selecting or providing an identifier of a particular tributary set, and ii) a bingo card for selecting ones of the data tributaries to add to the particular tributary set.

11. A system, comprising:
a network controller;
a plurality of network base stations;
a primary data link;
a plurality of secondary data links;
a data multiplexer coupled to each of the network base stations via respective ones of the secondary data links, and coupled to the network controller via the primary data link, wherein each of a plurality of data tributaries carries data over the secondary data links, between a particular one of the network base stations and the data multiplexer, and wherein multiplexed ones of the data tributaries carry data over the primary data link, between the data multiplexer and the network controller; and
a network analyzer having:
a network interface configured to receive and demultiplex the multiplexed ones of the data tributaries carried over the primary data link;
a stored mapping of data tributaries to one or more tributary sets;
a data tagger configured to i) access the stored mapping of data tributaries to one or more tributary sets, and ii) assign common data tags to the data carried by ones of the data tributaries mapped to common ones of the one or more tributary sets;
a data filter configured to filter the data based on the common data tags; and
a data analysis unit configured to analyze the filtered data and report a result of said analysis.

12. The system of claim 11, wherein the network controller is a radio network controller.

13. The system of claim 11, wherein the network base stations comprise cell phone towers.

14. The system of claim 11, wherein the data link comprises at least one optical fiber.

15. The system of claim 11, wherein the tributary sets correspond to different ones of the network base stations.

16. The system of claim 11, wherein the data analysis unit is configured to generate a report that identifies an item of the filtered data as being associated with a particular tributary set.

17. The system of claim 11, wherein the data analysis unit is configured to generate a report that includes statistics by tributary set.

18. A computer-implemented method, comprising:
receiving data carried by a plurality of data tributaries;
as the data is received, accessing a stored mapping of data tributaries to one or more tributary sets, and assigning common data tags to the data carried by ones of the data tributaries mapped to common ones of the one or more tributary sets;
filtering the data based on the common data tags;
analyzing the filtered data; and
outputting a result of said analysis.

19. The method of claim 18, further comprising:
displaying, via a graphical user interface (GUI), i) a mechanism for selecting or providing an identifier of a particular tributary set, and ii) a bingo card for selecting ones of the data tributaries to add to the particular tributary set.

20. The method of claim 18, further comprising:
displaying, via a graphical user interface (GUI), a mechanism for a user to define a configuration for the data tributaries of a tributary set.
